(19) United States
(12) Patent Application Publication
(10) Pub. No.: US 2025/0115756 A1
(43) Pub. Date: Apr. 10, 2025

(54) RESIN COMPOSITION, SUBSTRATE, AND COPPER CLAD LAMINATE THEREOF

(71) Applicant: NAN YA PLASTICS CORPORATION, Taipei City (TW)

(72) Inventors: Te-Chao Liao, Taipei City (TW); Hung-Yi Chang, Taipei City (TW); Chia-Lin Liu, Taipei City (TW); Ren-Yu Liao, Taipei City (TW)

(73) Assignee: NAN YA PLASTICS CORPORATION, Taipei City (TW)

(21) Appl. No.: 18/498,059

(22) Filed: Oct. 31, 2023

(30) Foreign Application Priority Data
Sep. 23, 2023 (TW) 112136451

(51) Int. Cl. C08L 63/00; B32B 5/02; B32B 15/14; B32B 15/20; C08J 5/24

(52) U.S. Cl. CPC C08L 63/00; B32B 5/02; B32B 15/14; B32B 15/20; C08J 5/244; B32B 2260/021; B32B 2260/046; B32B 2262/101; B32B 2307/306; B32B 2307/748; C08J 2363/00; C08J 2479/08; C08J 2483/04; C08L 2205/03

(57) ABSTRACT

The disclosure provides a resin composition, a substrate, and a copper clad laminate, wherein the resin composition includes a naphthalene ring epoxy resin, a bismaleimide resin, a crosslinking agent, polysiloxane, an accelerator, and a filler.

### CROSS-REFERENCE TO RELATED APPLICATION

This application claims the priority benefit of Taiwan application serial no. 112136451, filed on Sep. 23, 2023. The entirety of the above-mentioned patent application is hereby incorporated by reference herein and made a part of this specification.

### BACKGROUND

### Technical Field

The disclosure relates to a resin, and in particular to a resin composition, a substrate, and a copper clad laminate.

### Description of Related Art

In recent years, with the development of 5G communications, copper clad laminate materials have been developing towards the goals of higher dimensional stability and lower expansion and contraction, so that products have higher stability.

Moreover, there is a difference between the coefficient of thermal expansion of the current substrate and the coefficient of thermal expansion (CTE) of less than 2 ppm/° C. of the semiconductor material silicon substrate, which causes issues in material matching.

In particular, the coefficient of thermal expansion of a substrate made of a resin material is about 4 to 8 ppm/° C., which is still far from the CTE of the semiconductor material silicon substrate, so there is still room for improvement.

### SUMMARY

The disclosure provides a resin composition to reduce a CTE of a substrate and a copper clad laminate manufactured from the resin composition, so as to better match the CTE of a semiconductor material silicon substrate and improve dimensional stability, so that a product has higher stability.

The resin composition of the disclosure includes a naphthalene epoxy resin, a bismaleimide resin, a crosslinking agent, polysiloxane, an accelerator, and a filler.

In an embodiment of the disclosure, the filler includes silica.

In an embodiment of the disclosure, based on 100 parts by weight of the resin composition, the resin composition includes 20 to 70% of the naphthalene ring epoxy resin, 20 to 60% of the bismaleimide resin, 10 to 20% of the crosslinking agent, 0.5 to 2.0 phr of the polysiloxane, 0.05 to 1.0 phr of the accelerator, and 50 to 80% of the filler.

In an embodiment of the disclosure, the naphthalene ring epoxy resin includes HP4710, HP9500, HP6000, NC7000L, NC7300, or a combination thereof.

In an embodiment of the disclosure, an equivalent weight of the naphthalene ring epoxy resin is 170 to 250 g/eq.

In an embodiment of the disclosure, the bismaleimide resin includes BMI1000, BMI2300, KI50P, KI70, or a combination thereof.

In an embodiment of the disclosure, the polysiloxane includes polysiloxane diamine.

In an embodiment of the disclosure, the polysiloxane includes HP2000, KF8012, FM3311, or a combination thereof.

In an embodiment of the disclosure, an equivalent weight of the polysiloxane is 200 to 5000 g/eq.

In an embodiment of the disclosure, the silica is spherical.

In an embodiment of the disclosure, a size of the silica is 25 nm to 1.5 μm.

In an embodiment of the disclosure, a particle diameter of the silica includes a large particle diameter, a medium particle diameter, a small particle diameter, or a combined particle diameter thereof.

In an embodiment of the disclosure, the large particle diameter is 0.5 to 1.5 μm, the medium particle diameter is 0.12 to 0.45 μm, and the small particle diameter is 0.02 to 0.011 μm.

In an embodiment of the disclosure, the resin composition may further include a siloxane coupling agent.

In an embodiment of the disclosure, the siloxane coupling agent is 0.1 to 5 phr.

In an embodiment of the disclosure, a coefficient of thermal expansion of the resin composition is less than 3 ppm/° C.

In an embodiment of the disclosure, the coefficient of thermal expansion of the resin composition is less than 2 ppm/° C.

A substrate of the disclosure includes any one of the resin compositions.

A copper clad laminate of the disclosure includes a first copper foil, a second copper foil, a glass fiber cloth located between the first copper foil and the second copper foil, and a resin. The resin is formed from the resin composition and is located in the glass fiber cloth.

In an embodiment of the disclosure, the glass fiber cloth includes E-glass and S-glass.

In an embodiment of the disclosure, the resin may soak the glass fiber cloth through the resin composition and then be baked to form the resin in the glass fiber cloth.

Based on the above, the resin composition, the substrate, and the copper clad laminate provided by the disclosure have a lower CTE and may be less than 3 ppm/° C. or even less than 2 ppm/° C. to have characteristics such as better material matching with the semiconductor material silicon substrate having the CTE of less than 2 ppm/° C., higher heat resistance, optimal thermal stability, and higher dimensional stability.

### DESCRIPTION OF THE EMBODIMENTS

Hereinafter, embodiments of the disclosure are described in detail. However, these embodiments are exemplary, and the disclosure is not limited hereto.

A resin composition of the disclosure includes a naphthalene ring epoxy resin, a bismaleimide resin, a crosslinking agent, polysiloxane, an accelerator, and a filler, and may also include a siloxane coupling agent to provide a resin with high dimensional stability. Hereinafter, the various components are described in detail.

### Naphthalene Ring Epoxy Resin

The naphthalene ring epoxy resin may include HP4710, HP9500, HP6000, NC7000L, NC7300, or a combination thereof. The structure and the equivalent weight of the naphthalene ring epoxy resin are listed in Table 1 below, wherein the presence of two benzene rings can improve heat resistance, so that the resin is relatively stable under high temperatures.

Based on 100 parts by weight of the resin composition, the resin composition includes 20 to 70% of the naphthalene ring epoxy resin. The equivalent weight of the naphthalene ring epoxy resin is 170 to 250 g/eq.

TABLE 1

| Naphthalene ring | |
|---|---|
| epoxy resin | Structure |
| HP4710 | 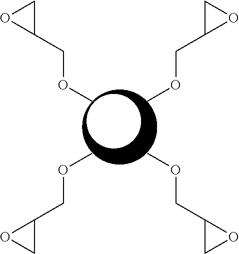 |
| HP9500 | 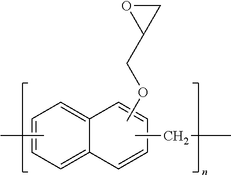 |
| HP6000 | 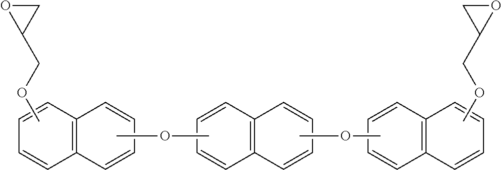 |
| NC7000L NC7300 | 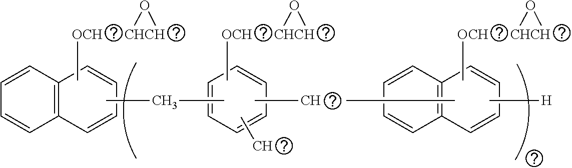 |

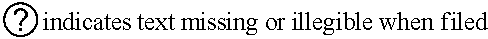

### Bismaleimide Resin

One of the purposes of adding the bismaleimide resin is to improve the overall thermal stability of the resin. The bismaleimide resin may include BMI1000, BMI2300, KI50P, KI70, or a combination thereof. The structure and the melting point of the bismaleimide resin are listed in Table 2 below.

Based on 100 parts by weight of the resin composition, the resin composition includes 20 to 60% of the bismaleimide resin.

TABLE 2

| Bismaleimide resin | Structure | Melting point |
|---|---|---|
| BMI1000 | 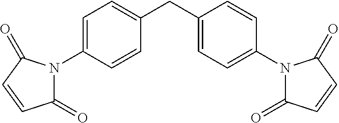 [SMILES: O=C1C=CC(=O)N1c1ccc(Cc2ccc(N3C(=O)C=CC3=O)cc2)cc1] | 147~168° C. |
| BMI2300 KI50P | 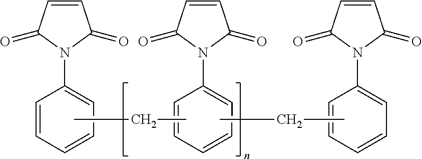 | 70~145° C. 89~121° C. |
| KI70 | 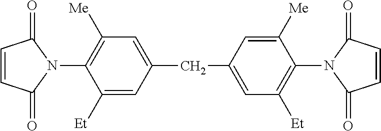 [SMILES: CCc1cc(Cc2cc(C)c(N3C(=O)C=CC3=O)c(CC)c2)cc(C)c1N1C(=O)C=CC1=O] | 164~166° C. |

### Crosslinking Agent

Based on 100 parts by weight of the resin composition, the resin composition includes 10 to 20% of the crosslinking agent.

### Polysiloxane

The polysiloxane is a long-chain siloxane and includes a polysiloxane diamine. The polysiloxane may include HP2000, KF8012, FM3311, or a combination thereof. The structure and the equivalent weight of the polysiloxane are listed in Table 3 below. HP2000 has a three-dimensional structure, while KF8012 and FM3311 are linear. The special microstructure of the polysiloxane is used to promote dispersion of raw materials and reduce the coefficient of thermal expansion (CTE) of a substrate to below 3 ppm/° C. or even below 2 ppm/° C., so that the resin has high dimensional stability.

Based on 100 parts by weight of the resin composition, the resin composition includes 0.5 to 2 phr of the polysiloxane. The equivalent weight of the polysiloxane is 200 to 5000 g/eq.

TABLE 3

| Polysiloxane | Structure |
|---|---|
| HP2000 | 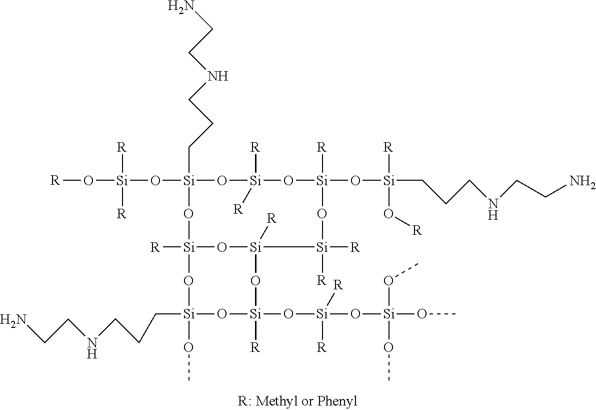 |
| KF8012 | 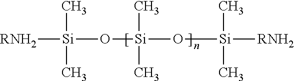 |
| FM3311 | 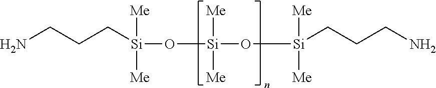 |

As shown in Table 3 above, the structures of HP2000, KF8012, and FM3311 all have a functional group-NH2, which may react with an epoxy structure of the naphthalene ring epoxy resin or a double bond structure of a BMI resin to improve the thermal stability of the reacted resin and reduce the CTE of the reacted resin. Moreover, the polysiloxane may also be regarded as a curing agent, and a long chain structure of the polysiloxane may improve the dispersion of the filler, such as silica, in the resin.

### Accelerator

Based on 100 parts by weight of the resin composition, the resin composition includes 0.05 phr to 1.0 phr of the accelerator to help carry out the reaction.

### Filler

The filler includes silica. The silica is spherical. The size of the silica is 25 nm to 1.5 μm. The particle diameter of the silica includes a large particle diameter, a medium particle diameter, a small particle diameter, or a combined particle diameter thereof. The particle diameter may be allocated according to the requirements. For example, to achieve a higher bulk density, two or three of the large particle diameter, the medium particle diameter, and the small particle diameter are selected. The large particle diameter is about 0.5 to 1.5 μm, the medium particle diameter is about 0.12 to 0.45 μm, and the small particle diameter is about 0.02 to 0.011 μm.

Based on 100 parts by weight of the resin composition, the resin composition includes 50 to 80% of the filler.

### Siloxane Coupling Agent

In addition to the naphthalene ring epoxy resin, the bismaleimide resin, the crosslinking agent, the polysiloxane, the accelerator, and the filler, the disclosure may also include the siloxane coupling agent. In addition to increasing the dispersion between raw materials like the polysiloxane, the siloxane coupling agent can also improve adhesion between the resin and a copper foil after the reaction. Based on 100 parts by weight of the resin composition, the resin composition includes 0.1 to 5 phr of the siloxane coupling agent.

### Substrate

The resin formed using the resin composition may be used to form the substrate.

### Copper Clad Laminate

The resin formed using the resin composition may be used in the copper clad laminate. The copper clad laminate includes a first copper foil, a second copper foil, a glass fiber cloth located between the first copper foil and the second copper foil, and the resin. The resin is formed from the resin composition and is located in the glass fiber cloth.

The glass fiber cloth may include the glass fiber cloth with different characteristics such as E-glass and S-glass.

The resin formed from the resin composition and located in the glass fiber cloth may be formed by soaking the glass fiber cloth in the resin composition and then processing by baking or other manners to form the resin in the glass fiber cloth.

### Preparation Manner

First, the resin composition, including the naphthalene epoxy resin, the bismaleimide resin, the crosslinking agent, the polysiloxane, the accelerator, the filler, and other raw materials, was stirred and mixed, a high speed homogenizing equipment was used for dispersion and mixing if necessary, and a formula solution was obtained.

Then, the glass fiber cloth was soaked in the formula solution, and then processed by baking or other manners.

Next, the glass fiber cloth soaked with the formula solution and the copper foil were combined and processed through hot pressing, and a copper foil substrate was obtained.

Finally, the copper foil was removed by a chemical method to obtain the substrate made of the resin composition disclosed in the disclosure.

### Examples and Comparative Examples

In view of different experimental themes, the disclosure uses the following formula ratio of each resin composition and uses the substrate made by the preparation manner to conduct a series of characteristic analysis tests listed in the following tables.

First, referring to Table 4 below, the naphthalene ring epoxy resin, a BPA epoxy resin, and a BPF epoxy resin were conducted the following tests.

TABLE 4

| | | | Comparative | Comparative |
|---|---|---|---|---|
| | | Example 1 | Example 1 | Example 2 |
| Formula ratio | | Naphthalene ring | BPA epoxy resin: 52.8% | BPF epoxy resin: 52.8% |
| | | epoxy resin: 55% | BMI: 37.2% | BMI: 37.2% |
| | | BMI: 35% | Crosslinking agent: 10% | Crosslinking agent: 10% |
| | | Crosslinking agent: 10% | Synthesis SiO₂: 75% | Synthesis SiO₂: 75% |
| | | Synthesis SiO₂: 75% | Accelerator: 0.05 phr | Accelerator: 0.05 phr |
| | | Accelerator: 0.05 phr | Silane: 0.17 phr | Silane: 0.17 phr |
| | | Silane: 0.17 phr | | |
| Cloth | | S-glass | S-glass | S-glass |
| Tg(DMA) | | >300° C. | >300° C. | >300° C. |
| PCT | Water | 0.46% | 0.97% | 0.99% |
| 2 hr | absorption | | | |
| | rate | | | |
| | Heat | OK | OK | OK |
| | resistance | | | |

| | | | |
|---|---|---|---|
| Dk/Df (10 GHz) | 3.73/0.00907 | 3.77/0.01012 | 3.82/0.00975 |
| Peeling (lb/in) | 4.3/4.2 | 4.8/4.6 | 4.9/4.8 |
| CTE (ppm/° C.) | 2.6 | 5.3 | 5.1 |

The structures and the equivalent weights of the BPA epoxy resin and the BPF epoxy resin are shown in Table 5 below.

TABLE 5

| Type of epoxy | | Equivalent weight |
|---|---|---|
| resin | Structure of epoxy resin | of epoxy resin |
| BPA epoxy resin | 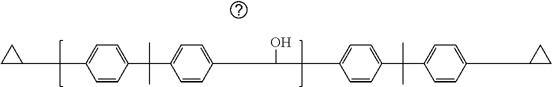 | About 185 g/eq |
| BPF epoxy resin | 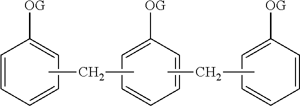 | About 165 g/eq |

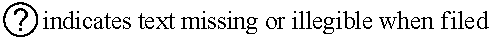

The results in Table 4 show that the CTE of Example 1 using the naphthalene ring epoxy resin is 2.6 ppm/° C., which is not only lower than the CTE (5.3 ppm/° C.) of the BPA epoxy resin of Comparative Example 1 and the CTE (5.1 ppm/° C.) of the BPF epoxy resin of Comparative Example 2, but also lower than the coefficient of thermal expansion of 4 to 8 ppm/° C. of the substrate made of a current resin material, and better matches the CTE of a semiconductor material silicon substrate. It is obvious that the naphthalene ring epoxy resin is more effective than the BPA epoxy resin and the BPF epoxy resin.

Referring to Table 6 below, the following tests were conducted on the effect of the presence of the polysiloxane and on different polysiloxane.

TABLE 6

| | | Example 1 | Example 2 | Example 3 | Example 4 |
|---|---|---|---|---|---|
| Formula ratio | | Naphthalene ring | Naphthalene ring | Naphthalene ring | Naphthalene ring |
| | | epoxy resin: 55% | epoxy resin: 55% | epoxy resin: 55% | epoxy resin: 55% |
| | | BMI: 35% | BMI: 35% | BMI: 35% | BMI: 35% |
| | | Crosslinking agent: 10% | Crosslinking agent: 10% | Crosslinking agent: 10% | Crosslinking agent: 10% |
| | | Synthesis SiO₂: 75% | Polysiloxane(HP2000): 6.25 g | Polysiloxane(KF8012): 6.25 g | Polysiloxane(FM3311): 6.25 g |
| | | Accelerator: 0.05 phr | Synthesis SiO₂: 75% | Synthesis SiO₂: 75% | Synthesis SiO₂: 75% |
| | | Silane: 0.17 phr | Accelerator: 0.05 phr | Accelerator: 0.05 phr | Accelerator: 0.05 phr |
| | | | Silane: 0.17 phr | Silane: 0.17 phr | Silane: 0.17 phr |
| Cloth | | S-glass | S-glass | S-glass | S-glass |
| Tg(DMA) | | >300° C. | >300° C. | 297° C. | 298 |
| PCT | Water | 0.46% | 0.32% | 0.44% | 0.45% |
| 2 hr | absorption | | | | |
| | rate | | | | |
| | Heat | OK | OK | OK | OK |
| | resistance | | | | |

| | | | | |
|---|---|---|---|---|
| Dk/Df (10 GHz) | 3.73/0.00907 | 3.69/0.01086 | 3.42/0.01182 | 3.48/0.01196 |
| Peeling (lb/in) | 4.3/4.2 | 4.6/4.5 | 4.2/4.4 | 4.3/4.5 |
| CTE (ppm/° C.) | 2.6 | 1.8 | 1.9 | 1.9 |

In Table 6, Examples 1 to 4 have the same formula ratio except the polysiloxane. Example 1 does not contain the polysiloxane, and Examples 2 to 4 contain 6.25 g of the polysiloxane, which is HP2000, KF8012, and FM3311 sequentially.

The results in Table 6 show that the CTE of Example 1 is 2.6 ppm/° C., which is lower than the coefficient of thermal expansion of 4 to 8 ppm/° C. of the substrate made of a current resin material and better matches the CTE of the semiconductor material silicon substrate.

In addition, the CTEs of Examples 2 to 4 having the polysiloxane are 1.8 ppm/° C., 1.9 ppm/° C., and 1.9 ppm/° C. sequentially, and are all less than 2 ppm/° C. The CTEs are lower than the CTE of Example 1 without the polysiloxane and are closer to the CTE of the semiconductor material silicon substrate to have optimal effect.

Referring to Table 7 below, the following tests were conducted on different naphthalene ring epoxy resins.

TABLE 7

| | | Example 5 | Example 6 | Example 7 | Example 8 | Example 9 |
|---|---|---|---|---|---|---|
| Formula ratio | | HP4710: 55% | HP9500: 55% | HP6000: 55% | NC7000L: 55% | NC7300: 55% |
| | | BMI: 35% | BMI: 35% | BMI: 35% | BMI: 35% | BMI: 35% |
| | | Crosslinking | Crosslinking | Crosslinking | Crosslinking | Crosslinking |
| | | agent: 10% | agent: 10% | agent: 10% | agent: 10% | agent: 10% |
| | | Synthesis SiO₂: | Synthesis SiO₂: | Synthesis SiO₂: | Synthesis SiO₂: | Synthesis SiO₂: |
| | | 75% | 75% | 75% | 75% | 75% |
| | | Accelerator: | Accelerator: | Accelerator: | Accelerator: | Accelerator: |
| | | 0.05 phr | 0.05 phr | 0.05 phr | 0.05 phr | 0.05 phr |
| | | Silane: 0.17 phr | Silane: 0.17 phr | Silane: 0.17 phr | Silane: 0.17 phr | Silane: 0.17 phr |
| Cloth | | S-glass | S-glass | S-glass | S-glass | S-glass |
| B-Stage | | 130° C. | 130° C. | 130° C. | 130° C. | 130° C. |
| Tg(DMA) | | >300° C. | >300° C. | >300° C. | >300° C. | >300° C. |
| PCT | Water | 0.46% | 0.32% | 0.41% | 0.50% | 0.47% |
| 2 hr | absorption rate | | | | | |
| | Heat resistance | OK | OK | OK | OK | OK |

| | | | | | |
|---|---|---|---|---|---|
| Dk/Df (10 GHz) | 3.73/0.00907 | 3.75/0.00937 | 3.62/0.00884 | 3.95/0.0084 | 3.68/0.00940 |
| Peeling (lb/in) | 4.3/4.2 | 4.6/4.5 | 4.1/4.2 | 4.1/4.0 | 4.3/4.0 |
| CTE (ppm/° C.) | 2.6 | 2.8 | 2.7 | 2.9 | 2.8 |

In Table 7, Examples 5 to 9 have the same formula ratio except for the naphthalene ring epoxy resin used. The naphthalene ring epoxy resins used in Examples 2 to 6 are HP4710, HP9500, HP6000, NC7000L, and NC7300 sequentially.

The results in Table 7 show that the CTEs of Examples 5 to 9 are 2.6 ppm/° C., 2.8 ppm/° C., 2.7 ppm/° C., 2.9 ppm/° C., and 2.8 ppm/° C. sequentially, which are lower than the coefficient of thermal expansion of 4 to 8 ppm/° C. of the substrate made of a current resin material and better match the CTE of the semiconductor material silicon substrate.

Referring to Table 8 below, the following tests were conducted on different bismaleimide resins.

TABLE 8

| | | Example 10 | Example 11 | Example 12 | Example 13 |
|---|---|---|---|---|---|
| Formula ratio | | Naphthalene ring | Naphthalene ring | Naphthalene ring | Naphthalene ring |
| | | epoxy resin: 55% | epoxy resin: 55% | epoxy resin: 55% | epoxy resin: 55% |
| | | BMI1000: 35% | BMI2300: 35% | KI50P: 35% | KI70: 35% |
| | | Crosslinking agent: 10% | Crosslinking agent: 10% | Crosslinking agent: 10% | Crosslinking agent: 10% |
| | | Synthesis SiO₂: 75% | Synthesis SiO₂: 75% | Synthesis SiO₂: 75% | Synthesis SiO₂: 75% |
| | | Accelerator: 0.05 phr | Accelerator: 0.05 phr | Accelerator: 0.05 phr | Accelerator: 0.05 phr |
| | | Silane: 0.17 phr | Silane: 0.17 phr | Silane: 0.17 phr | Silane: 0.17 phr |
| Cloth | | S-glass | S-glass | S-glass | S-glass |
| B-Stage | | 130° C. | 130° C. | 130° C. | 130° C. |
| Tg(DMA) | | >300° C. | >300° C. | >300° C. | >300° C. |
| PCT | Water | 0.43% | 0.39% | 0.38% | 0.40% |
| 2 hr | absorption | | | | |
| | rate | | | | |
| | Heat | OK | OK | OK | OK |
| | resistance | | | | |

| | | | | |
|---|---|---|---|---|
| Dk/Df (10 GHz) | 3.83/0.01207 | 3.85/0.01370 | 3.87/0.01405 | 3.41/0.0081 |
| Peeling (lb/in) | 4.1/4.1 | 4.3/4.1 | 4.2/4.4 | 4.3/4.2 |
| CTE (ppm/° C.) | 2.9 | 2.8 | 2.7 | 2.8 |

In Table 8, Examples 10 to 13 have the same formula ratio except for the naphthalene ring epoxy resin used. The bismaleimide resins used in Examples 10 to 13 are BMI1000, BMI2300, KI50P, and KI70 sequentially.

The results in Table 8 show that the CTEs of Examples 10 to 13 are 2.9 ppm/° C., 2.8 ppm/° C., 2.7 ppm/° C., and 2.8 ppm/° C. sequentially, which are lower than the coefficient of thermal expansion of 4 to 8 ppm/° C. of the substrate made of a current resin material and better match the CTE of the semiconductor material silicon substrate.

Referring to Table 9 below, the following tests were conducted on different glass fiber cloths.

TABLE 9

| | | Comparative | Comarative |
|---|---|---|---|
| | | Example 3 | Example 4 |
| Formula ratio | | Naphthalene ring | Naphthalene ring |
| | | epoxy resin: 55% | epoxy resin: 55% |
| | | BMI: 35% | BMI: 35% |
| | | Crosslinking agent: 10% | Crosslinking agent: 10% |
| | | Synthesis SiO₂: 75% | Synthesis SiO₂: 75% |
| | | Accelerator: 0.05 phr | Accelerator: 0.05 phr |
| | | Silane: 0.17 phr | Silane: 0.17 phr |
| Cloth | | E-glass | S-glass |
| B-Stage | | 130° C. | 130° C. |
| Tg(DMA) | | >300° C. | >300° C. |
| PCT | Water | 0.47% | 0.46% |
| 2 hr | absorption | | |
| | rate | | |
| | Heat | OK | OK |
| | resistance | | |

| | | |
|---|---|---|
| Dk/Df (10 GHz) | 3.75/0.010034 | 3.73/0.00907 |
| Peeling (lb/in) | 4.2/4.1 | 4.3/4.2 |
| CTE (ppm/° C.) | 5.6 | 2.6 |

In Table 9, Comparative Examples 3 and 4 have the same formula ratio except for the type of the glass fiber cloth used.

The results in Table 9 show that the CTEs of Comparative Examples 3 and 4 are 5.6 ppm/° C. and 2.6 ppm/° C. sequentially, which are lower than the coefficient of thermal expansion of 4 to 8 ppm/° C. of the substrate made of a current resin material and better match the CTE of the semiconductor material silicon substrate.

In summary, the resin composition, the substrate, and the copper clad laminate provided by the disclosure have a lower CTE and may be less than 3 ppm/° C. or even less than 2 ppm/° C. to have characteristics such as better material matching with the semiconductor material silicon substrate having the CTE of less than 2 ppm/° C., higher heat resistance, optimal thermal stability, and higher dimensional stability.

What is claimed is:

1. A resin composition, comprising:
a naphthalene ring epoxy resin;
a bismaleimide resin;
a crosslinking agent;
a polysiloxane;
an accelerator; and
a filler.

2. The resin composition according to claim 1, wherein the filler comprises silica.

3. The resin composition according to claim 1, wherein based on 100 parts by weight of the resin composition, the resin composition comprises:
20 to 70% of the naphthalene ring epoxy resin;
20 to 60% of the bismaleimide resin;
10 to 20% of the crosslinking agent;
0.5 to 2.0 phr of the polysiloxane;
0.05 phr to 1.0 phr of the accelerator; and
50 to 80% of the filler.

4. The resin composition according to claim 1, wherein the naphthalene ring epoxy resin comprises HP4710, HP9500, HP6000, NC7000L, NC7300, or a combination thereof.

5. The resin composition according to claim 1, wherein an equivalent weight of the naphthalene ring epoxy resin is 170 to 250 g/eq.

6. The resin composition according to claim 1, wherein the bismaleimide resin comprises BMI1000, BMI2300, KI50P, KI70, or a combination thereof.

7. The resin composition according to claim 1, wherein the polysiloxane comprises polysiloxane diamine.

8. The resin composition according to claim 1, wherein the polysiloxane comprises HP2000, KF8012, FM3311, or a combination thereof.

9. The resin composition according to claim 1, wherein an equivalent weight of the polysiloxane is 200 to 5000 g/eq.

10. The resin composition according to claim 2, wherein the silica is spherical.

11. The resin composition according to claim 2, wherein a size of the silica is 25 nm to 1.5 μm.

12. The resin composition according to claim 2, wherein a particle diameter of the silica comprises a large particle diameter, a medium particle diameter, a small particle diameter, or a combined particle diameter thereof.

13. The resin composition according to claim 12, wherein the large particle diameter is 0.5 to 1.5 μm, the medium particle diameter is 0.12 to 0.45 μm, and the small particle diameter is 0.02 to 0.011 μm.

14. The resin composition according to claim 1, further comprising a siloxane coupling agent.

15. The resin composition according to claim 14, wherein the siloxane coupling agent is 0.1 to 5 phr.

16. The resin composition according to claim 1, wherein a coefficient of thermal expansion of the resin composition is less than 3 ppm/° C.

17. A substrate, comprising the resin composition according to claim 1.

18. A copper clad laminate, comprising:
a first copper foil;
a second copper foil;
a glass fiber cloth, located between the first copper foil and the second copper foil; and
a resin, formed from the resin composition according to claim 1 and located in the glass fiber cloth.

19. The copper clad laminate according to claim 18, wherein the glass fiber cloth comprises E-glass and S-glass.

20. The copper clad laminated according to claim 18, wherein the resin soaks the glass fiber cloth in the resin composition and then is baked to form the resin in the glass fiber cloth.
